(19) United States
(12) Patent Application Publication
(10) Pub. No.: US 2026/0324611 A1
(43) Pub. Date: Oct. 22, 2026

(54) Shark Control Device

(71) Applicant: Surfsafe Pty Ltd, Osborne Park, WA (AU)

(72) Inventor: David Smith, Osborne Park, WA (AU)

(21) Appl. No.: 19/114,005

(22) PCT Filed: Oct. 5, 2023
(86) PCT No.: PCT/AU2023/050970

§ 371 Date: Mar. 21, 2025

(30) Foreign Application Priority Data
Oct. 5, 2022 (AU) 2022902895

(51) Int. Cl. A01K 91/06; A01K 85/01; A01M 29/06; A01M 29/12; A01M 29/16; A01M 29/24

(52) U.S. Cl. CPC A01K 91/06; A01K 85/015; A01M 29/06; A01M 29/12; A01M 29/16; A01M 29/24

(57) ABSTRACT

A shark control device for a line including a hook member for catching an aquatic animal in an aquatic environment, the device comprising: (a) a shark deterrent having a predetermined buoyancy such that, when the line is retrieved in the aquatic environment, the shark deterrent is adapted to move from a first position at which it is located above and spaced apart from or excludes the hook member to a second position at which it is adjacent to or encompasses the hook member.

### FIELD OF THE INVENTION

The present invention relates to a shark control device for a fishing line. The present invention also relates to a method of fishing used said device.

### BACKGROUND OF THE INVENTION

Fishing is a popular recreational sport and commercial line fishing is a very valuable industry. However, there are increasing reports of catches being lost to shark predation. In this regard, it is not uncommon for a hooked fish to be predated by a shark before it can be retrieved by the fisher.

Whilst shark repellent devices have been designed none of them are particularly suited for use with line fishing. They are either too complex, cumbersome, expensive, or otherwise adversely impact on the fishing experience. This is even more so the case with prior art electromagnetic shark repellent devices.

The present invention seeks to provide a shark control device and method of fishing that addresses problems with prior art devices or at least provides a useful alternative to currently available devices and methods.

### SUMMARY OF THE INVENTION

According to a first aspect, the present invention provides a shark control device for a line including a hook member for catching an aquatic animal in an aquatic environment, the device comprising:
(a) a shark deterrent having a predetermined buoyancy such that, when the line is retrieved in the aquatic environment, the shark deterrent is adapted to move from a first position at which it is located above and spaced apart from or excludes the hook member to a second position at which it is adjacent to or encompasses the hook member.

The present invention also provides a shark control device for a line including a hook member for catching an aquatic animal in an aquatic environment, the device comprising a shark deterrent in the form of an electromagnetic repellent having a predetermined buoyancy such that, when the line is retrieved in the aquatic environment, the electromagnetic repellent is adapted to move from a first position at which it is located above and spaced apart from or excludes the hook member to a second position at which it is adjacent to or encompasses the hook member.

According to a second aspect, the present invention also provides a method of fishing for an aquatic animal in an aquatic environment using a line including a hook member for catching the aquatic animal, the method comprising the steps of:
(a) attaching a shark control device, including a shark deterrent having a predetermined buoyancy, to the line; and
(b) deploying the line in the aquatic environment;

wherein, when the line is retrieved in the aquatic environment, the shark deterrent moves from a first position at which it is located above and spaced apart from or excludes the hook member to a second position at which it is adjacent to or encompasses the hook member.

### BRIEF DESCRIPTION OF THE DRAWINGS

FIG. 1A is a perspective view of an electromagnetic shark control device according to a preferred embodiment of a first aspect of the present invention, fitted to a fishing line;

FIG. 1B depicts the electrical components that form part of the device in FIG. 1A;

FIG. 2A illustrates how the electromagnetic shark control device in FIG. 1A operates in use across four configurations (A-D); and

FIG. 2 illustrates how the electromagnetic shark control device in FIG. 1A operates in use in an additional configuration (E).

### DETAILED DESCRIPTION OF THE INVENTION

According to a first aspect, the present invention provides a shark control device for a line including a hook member for catching an aquatic animal in an aquatic environment, the device comprising:
(b) a shark deterrent having a predetermined buoyancy such that, when the line is retrieved in the aquatic environment, the shark deterrent is adapted to move from a first position at which it is located above and spaced apart from or excludes the hook member to a second position at which it is adjacent to or encompasses the hook member.

For the purposes of the present invention the term “hook member” includes a hook or any other device that may be attached to a line to catch an aquatic animal such as a fish. The hook member may be adapted to retain a bait for the aquatic animal or may comprise a lure or some other attractant for the aquatic animal.

Preferably, the aquatic animal is a fish.

Preferably, the fish is a non-cartilaginous fish.

Preferably, the aquatic environment is a body of salt water such as the ocean or a body of fresh water such as a river or lake. The aquatic environment may also be a body of brackish water such as an estuary.

For the purposes of the present invention the term “shark” includes any and all elasmobranchs and cartilaginous fish such as sharks, rays and skates.

The shark deterrent may be a repellent selected from the list comprising: a magnetic repellent, an electrical repellent, an acoustic repellent, a semiochemical repellent and a visual repellent.

The magnetic repellent may comprise a permanent magnet.

The electrical repellent may comprise an electromagnetic repellent.

The semiochemical repellent may comprise a pheromone, an allomone and/or a kairomone.

The visual repellent may comprise a repellent adapted to mimic a visual sign that repels and/or deters a shark when they encounter it in nature.

For the purposes of the present invention the term “buoyancy” means a tendency to float in an aquatic environment. In the context of the present invention, something is more buoyant than something else if it has a greater tendency to float in an aquatic environment.

Preferably, the shark deterrent is more buoyant than the line.

Preferably, when in the first position, a main longitudinal axis of the shark deterrent extends from the line and towards a surface of the aquatic environment. Even more preferably, when in the first position, the main longitudinal axis of the shark deterrent defines a first angle with the line, such as an acute angle. Even more preferably the first angle is about 35-55°, 40-50° or 45°.

Preferably, when in the second position, the main longitudinal axis of the shark deterrent extends from the line and away from the surface of the aquatic environment. Even more preferably, when in the second position, the main longitudinal axis of the shark deterrent defines a second angle with the line such as an obtuse angle. Even more preferably the second angle is at least about 150°, 160°, 170° or 175°.

Preferably, the movement between said first and second positions comprises reorientation of the shark deterrent.

Preferably, the reorientation comprises inversion of the shark deterrent.

Preferably, the shark deterrent is adapted to be attached to the line at an attachment point on the line. Even more preferably, the shark deterrent is adapted to be releasably attached to the line at the attachment point on the line. Preferably, the shark deterrent is adapted to fixedly attached to the line at the attachment point on the line.

When the shark deterrent is attached to the line at the attachment point on the line, the reorientation may comprise the shark deterrent pivoting around the attachment point on the line.

Preferably, the attachment point on the line comprises a loop, a swivel or a clip.

Preferably, the shark deterrent comprises a line attachment member compatible with the attachment point on the line. Preferably, the line attachment member comprises a loop, swivel or a clip.

Preferably, the shark deterrent further comprises a means for attracting the aquatic animal or another animal upon which the aquatic animal predates. Said means may comprise a light source such as an LED. Preferably, the light source is adapted to produce a green light.

Applicant has found that the rigidity of the shark deterrent impacts on the likelihood of the shark control device becoming entangled with or otherwise negatively impacting on the line. Preferably, the shark deterrent is semi-rigid. For example, the rigidity of the shark deterrent may be quantified as a deflection of 8-12, 9-11 or 10 mm over a 1 m span upon application of a 10 g load. Preferably, according to Youngs Modulus (GPa), the shark deterrent comprises a rigidity, of about 0.15 to 0.30, 0.17 to 0.28, 0.19 to 0.26 or about 0.21-0.24. The shark deterrent may comprise a rigidity, according to the Rockwell Hardness scale, of about D42-50.

Preferably, the shark deterrent is capable of plastic deformation insofar as it is adapted to change shape upon the application of stress and does not return to its original shape when the stress is removed. Preferably, the shark deterrent is flexible.

Preferably, the shark deterrent is an electromagnetic repellent. Thus, according to a preferred from of the first aspect of the invention, the present invention provides a shark control device for a line including a hook member for catching an aquatic animal in an aquatic environment, the device comprising a shark deterrent in the form of an electromagnetic repellent having a predetermined buoyancy such that, when the line is retrieved in the aquatic environment, the electromagnetic repellent is adapted to move from a first position at which it is located above and spaced apart from or excludes the hook member to a second position at which it is adjacent to or encompasses the hook member.

Preferably, the electromagnetic repellent comprises:
(a) an electricity source;
(b) a first electrode;
(c) a second electrode; and
(d) an electrical conductor between said electrodes.

Preferably, the electricity source is a battery such as a rechargeable battery.

Preferably, the electricity source is a source of direct current electricity. Even more preferably, the electricity source is a source of about 3 to 4V of direct current such as 3.7V.

Preferably, the electricity source is activated to power the shark control device by a switch that is actuated upon contact with the aquatic environment.

Preferably, the switch is located in the first housing. Even more preferably, the switch is located in the charging port.

Preferably, when the shark control device is in use, the first electrode is located proximal or adjacent to the line.

Even more preferably, when the shark control device is in use, the first electrode is fixedly attached to the line.

The first electrode may comprise a cathode.

Preferably, the first electrode comprises a first housing.

Preferably, the first housing is formed of stainless steel.

When the first electrode is proximal to the line, the first housing may comprise the line attachment member.

Preferably, the first housing is adapted to receive the electricity source.

Preferably, the first housing comprises the electricity source.

Preferably, the first housing includes a charging port for the electricity source.

Preferably, the first housing is water tight.

Preferably, the first housing further comprises the means for attracting the aquatic animal.

Preferably, the first housing further comprises at least one electrical component such as a circuit.

Preferably, the first housing is cylindrical or tubular shaped.

Preferably, the first housing has a surface area (cm²) to volume (cm³) ratio of about 1.25-1.65, 1.35-1.55, 1.4-1.5 or about 1.45. Preferably, the circuit comprises one or more of a diode and an inverter.

Preferably, the inverter is adapted to increase the voltage of electricity from the electricity source to about 150 to 250V, such as 200V.

Preferably, the circuit is adapted to generate the electricity in pulses. Preferably the pulses are every 4 to 6 seconds such as 5 seconds.

Preferably, the at least one electrical component is electrically isolated or insulated. For example, the electrical component can be encapsulated in resin or a similar substance.

Preferably, the first housing is less buoyant than the second housing. Even more preferably, the first housing is less buoyant than the aquatic environment.

In an aquatic environment with a density of about 1.205 g/cm³, the first housing may have buoyant force of about 0.3 to 0.4N, about 0.32 to 0.38N or about 0.34-0.36N. In one example of the invention, in an aquatic environment with a density of about 1.205 g/cm³, the first housing has a buoyant force of about 0.3518N.

Preferably, the first housing further comprises a charge indicator for the electricity source. Preferably, the charge indicator is a light. Preferably, the charge indicator indicates when the electricity source is receiving charge. Preferably, the charge indicator indicates when the electricity source has charge and/or when the electricity source has a low charge.

Whilst the above description includes a description of the first housing including one or more of the electrical components, it will be appreciated that the electrical components could also be incorporated in the second housing. However, in such a scenario, the second housing would need to be modified to ensure it still had the requisite buoyancy in light of the additional mass.

Preferably, when the shark control device is in use, the second electrode is located distal to and/or is displaced laterally from the line.

Preferably, the second electrode is located at or near a free end of the device, when in use.

The second electrode may comprise an anode.

Preferably, the second electrode comprises a second housing.

Preferably, the second housing is formed of stainless steel.

Preferably, the second housing is air and water tight or fluid tight.

Preferably, the second housing is cylindrical or tubular shaped.

Preferably, the second housing has a surface area (cm²) to volume (cm³) ratio of about 1.25-1.65, 1.35-1.55, 1.4-1.5 or about 1.45. Preferably, the second housing is more buoyant than the aquatic environment. Even more preferably, the second housing is more buoyant than the first housing and the line.

Preferably, the second housing contains gas, such as air, under pressurise.

Preferably, the second housing has a mass lower than the first housing.

In an aquatic environment with a density of about 1.205 g/cm³, the second housing may have buoyant force of about 0.65 to 0.75N, about 0.68 to 0.72N or about 0.7-0.71N. In one example of the invention, in an aquatic environment with a density of about 1.205 g/cm³, the second housing has a buoyant force of about 0.7036N.

Whilst the cathode has been described as being at the first end and the anode described as being at the second, it will be appreciated that their locations can be reversed or interchanged.

It will be appreciated that second housing could also include the electrical components that are described above in relation to the first housing. However, in such a scenario, the second housing would need to be modified to ensure it still had the requisite buoyancy in light of the additional mass.

Preferably, the electrical conductor comprises a wire or cable surrounded by an insulated conduit.

Preferably, the electrical conductor is more buoyant than the aquatic environment.

The rigidity of the electrical conductor impacts on the likelihood of the shark control device becoming entangled with or otherwise negatively impacting on the line. Preferably, the electrical conductor is semi-rigid. For example, the rigidity of the electrical conductor may be quantified as a deflection of 8-12, 9-11 or 10 mm over a 1 m span upon application of a 10 g load. Preferably, according to Youngs Modulus (GPa), the electrical conductor comprises a rigidity, of about 0.15 to 0.30, 0.17 to 0.28, 0.19 to 0.26 or about 0.21-0.24. The electrical conductor may comprise a rigidity, according to the Rockwell Hardness scale, of about D42-50.

Preferably, the electrical conductor is capable of plastic deformation insofar as it is adapted to change shape upon the application of stress and does not return to its original shape when the stress is removed. Preferably, the electrical conductor is flexible.

Preferably, the wire or cable is formed of copper or aluminium.

Preferably, the rigidity of the insulated conduit is temperature sensitive. Preferably, the insulated conduit is more rigid at lower temperatures, such as those encountered in the aquatic environments.

Preferably, the insulated conduit is formed from a material with at least one of the following properties:

| | ASTM Test | |
|---|---|---|
| Property | (see https://www.astm.org/) | Value |
| Specific gravity | D792 | 0.91-0.925 |
| Tensile strength yield | D638 | 1,400-2000 |
| Izod impact - notched | D256 | >16 |
| Vicat softening | D1525 | 219 °F |
| temperature | | |
| Hardness - Rockwell | D785 | D42-50 |
| Continuous use temp | — | 174 °F |
| Deflection temp @66 psi | D648 | 124 °F |
| Co Thermal Expansion | D696 | 4.6-5.5 × 10⁻⁵ |

Preferably, the insulated conduit is formed of a polymer such as polyethylene or low density polyethylene (LDPE).

Preferably, the electrical conductor is attached to the first and second electrodes via a suitable electrical fitting.

When the shark control device is an electromagnetic shark control device it may be adapted to produce an electromagnetic field with one or more of the properties in the table below:

| Property | Value | |
|---|---|---|
| Electromagnetic strength | 0.5-1.5 | V/m; |
| | 0.75-1.25 | V/m; |
| | 0.85-1.15 | V/m; |
| | 0.95-1.05 | V/m; or |
| | About 1 V/m | |
| Electromagnetic pulse | 3-7 | pulses/second; |
| | 4-6 | pulses/second; or |

About 5 pulses/second.

According to a second aspect, the present invention provides a method of fishing for an aquatic animal in an aquatic environment using a line including a hook member for catching the aquatic animal, the method comprising the steps of:
(c) attaching a shark control device, including a shark deterrent having a predetermined buoyancy, to the line; and
(d) deploying the line in the aquatic environment;

wherein, when the line is retrieved in the aquatic environment, the shark deterrent moves from a first position at which it is located above and spaced apart from or excludes the hook member to a second position at which it is adjacent to or encompasses the hook member.

Preferably, the shark deterrent is as described herein relation to the first aspect of the invention.

Even more preferably, the shark deterrent is an electromagnetic repellent, such as the electromagnetic repellent as described herein in relation to the first aspect of the invention.

### Advantages

Whilst not limited to the following applicant believes the present invention has a number of advantages including one or more of the following:
(a) the buoyancy of the device helps address entanglement between the device and the fishing line as it improves separation of the device from the fishing line until the fishing line is retrieved;
(b) the surface area to volume ratio of the device helps address entanglement between the device and the fishing line as it decreases the impact of fluid currents on the device, when in use;
(c) the device offers more effective and comprehensive protection of aquatic animals caught whilst fishing as protection is provided as soon as the animal is caught and the line retrieved; and
(d) when the device is in use and fixedly attached to a fishing line it offers a more convenient solution to other devices that are adapted to move along the fishing line and/or be attached and detached from a fishing line during use.

### General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Any document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness. None of the cited material or the information contained in that material should, however, be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g., size, length, strength etc). A range of values will be understood to include all values within the range, including the values defining the range, and values adjacent to the range which lead to the same or substantially the same outcome as the values immediately adjacent to that value which defines the boundary to the range.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. In the various Figures the same reference numerals have been used to identify similar elements.

### Detailed Description of the Preferred Embodiments

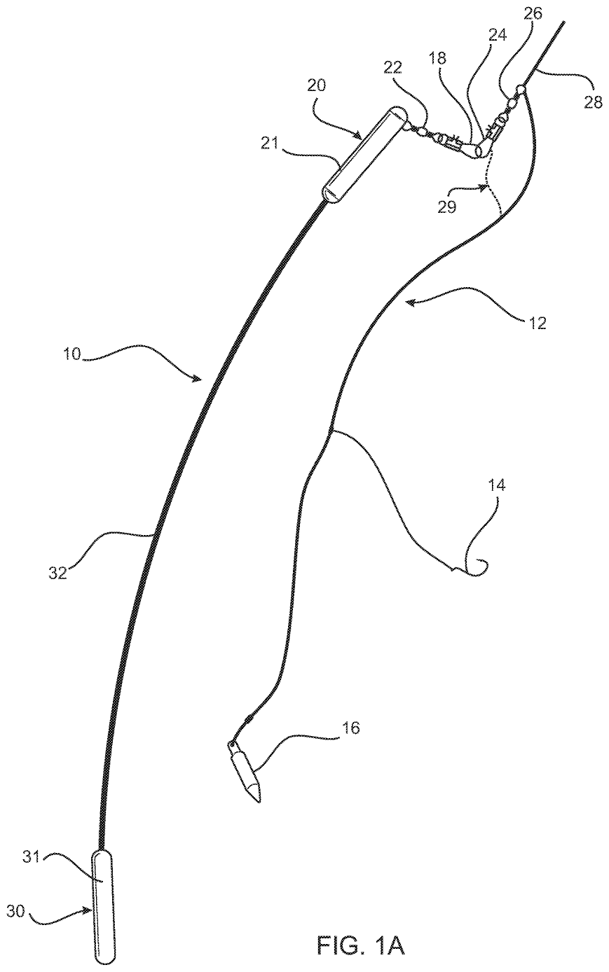

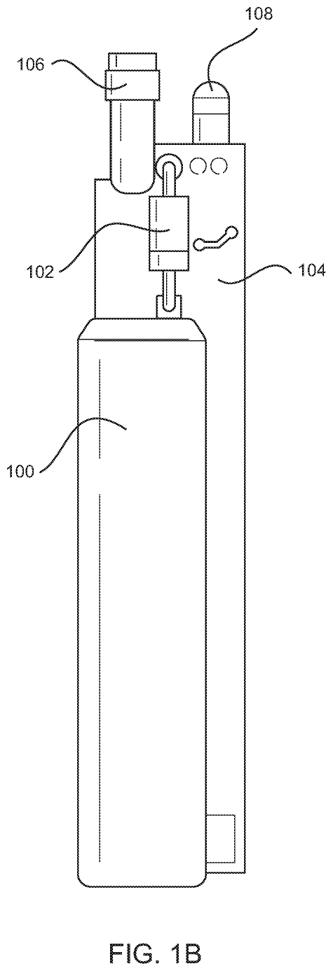

An embodiment of the first aspect of the present invention in the form of an electromagnetic shark control device is depicted in FIGS. 1A and 1s generally indicated by the numeral 10. The device 10 is shown attached to a line in the form of a fishing line 12 that includes a hook member in the form of a fishing hook 14 and a weight or sinker 16. The device 10 is shown attached at a point above the fishing hook 14 and extends to a point below the fishing hook 14, reflecting an orientation that the device would assume when the device is in use and the fishing line 12 is being retrieved.

The device 10 includes a line attachment member in the form of a first clip 18 that is attached to the first electrode 20 via a first swivel 22. The first clip 18 is also attached to a second clip 24 that is attached to the fishing line 12 via a second swivel 26. It will be appreciated that various changes to standard fishing components could be made including omitting the second clip 24 and instead having first clip 18 linked directly with second swivel 26. The first clip 18 could also be attached to second swivel 26 and the line 12 could extend from the second clip (see dotted line 29) instead of being attached to second swivel 26. The main line 28 extends back to a fishing reel (not shown). It will be appreciated that the manner in which the device 10 is connected to the fishing line 12 and the items of fishing tackle used to effect the connections may be varied depending on the nature of the fishing being undertaken. For example, there could be a plurality of fishing hooks 14.

The first electrode 20 comprises a first housing 21 that is elongate, water tight, has a generally circular shaped cross section and is formed from stainless steel. The first housing is tubular and has a relatively small surface area (cm²) to volume (cm³) ratio, in the order of 1.45, to reduce the resulting drag when the device 10 is in use and exposed to the currents that exist in aquatic environments such as oceans.

Located inside the first housing 21, and best shown in FIG. 1B, are an electricity source in the form of a rechargeable 3.7V lithium-ion battery 100 and electrical components in the form of a diode 102 mounted to a printed circuit board 104 includes an inverter for converting the direct current from the battery 100 to alternating current of about 200V. Whilst not shown in FIG. 1B, the electrical components inside the first housing 21 are encapsulated in resin to electrically isolate or insulated them. The printed circuit board 104 can include other components such as a battery circuit overload chip, a thermal protection chip and/or a circuit charging chip.

The first housing 21 includes a means for attracting the aquatic animal or an animal upon which the aquatic animal predates in the form of a green LED light 108. In addition, the first housing 21 may include a charge indicator for the electricity source in the form of a charge indicator light (not shown) that indicates one or more of: when the electricity source is receiving charge; when the electricity source has charge; and/or when the electricity source has a low charge.

The first housing 21 also includes a charging port for the battery 100 in the form of a female connector (not shown) located at the free end of the first housing 21 that is adapted to receive the compatible male connector of a charger (not shown). The female connector (not shown) is operably connected to a switch 106 (see FIG. 1B) that is actuated upon contact with the aquatic environment enabling the device 10 to turn on when it is submerged in the aquatic environment. This reduces the likelihood of a user being adversely impacted when handling the device 10.

The electromagnetic shark control device 10 further comprises a second electrode 30 comprising a second housing 31 that is elongate, fluid tight, has a generally circular shaped cross section and is formed from stainless steel. The second housing 31 is more buoyant than the aquatic environment and the first housing 21 and is located at a free end of the device 10. It has a relatively small surface area (cm²) to volume (cm³) ratio, in the order of 1.45, to reduce the resulting drag when the device 10 is in use and exposed to the currents that exist in aquatic environments such as oceans.

The first 21 and second 31 housings are connected by an electrical conductor in the form of insulated copper wire 32. The copper wire (not shown) is surrounded by an insulated conduit formed from low density polyethylene with the following properties:

| | ASTM Test | |
|---|---|---|
| Property | (see https://www.astm.org/) | Value |
| Specific gravity | D792 | 0.91-0.925 |
| Tensile strength yield | D638 | 1,400-2000 |
| Izod impact - notched | D256 | >16 |
| Vicat softening | D1525 | 219 °F |
| temperature | | |
| Hardness - Rockwell | D785 | D42-50 |
| Continuous use temp | — | 174 °F |
| Deflection temp @66 psi | D648 | 124 °F |
| Co Thermal Expansion | D696 | 4.6-5.5 × 10⁻⁵ |

The insulated copper wire 32 is approximately 85 cm in length, is more buoyant than the aquatic environment and is semi-rigid to decrease the likelihood of the shark control device 10 becoming entangled with or otherwise negatively impacting on the fishing line 12. The insulated copper wire 32 is flexible and capable of plastic deformation. The rigidity of the insulated copper wire 32 is temperature sensitive and is more rigid at lower temperatures, such as those encountered in the aquatic environments.

One end of the insulated copper wire 32 is attached to the first electrode and the other end is attached to the second electrode via suitable electrical fittings.

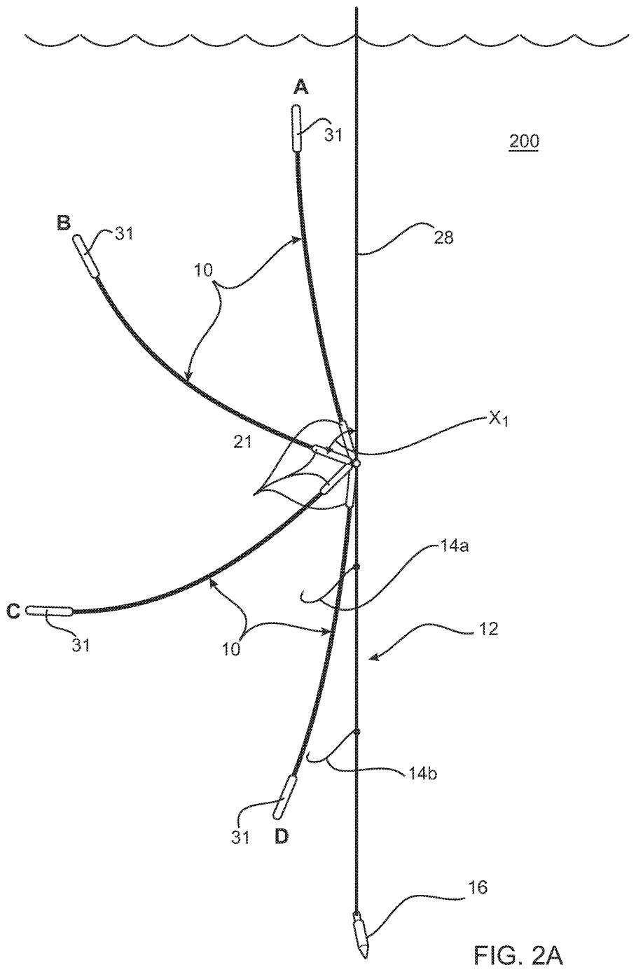

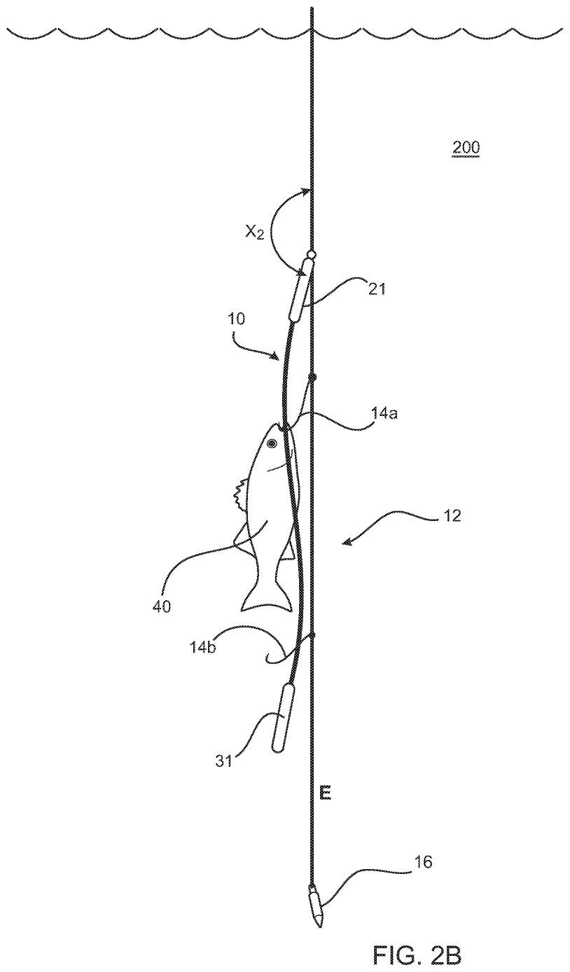

FIGS. 2A and 2B show the device 10 in use and in 3 different configurations A-C.

Once the device 10 is in the aquatic environment, in the form of sea water 200, the switch in the first housing 21 is actuated to turn on the device 10 resulting in the formation of an electromagnetic field with a strength of about 1V/m and about 5 pulses/second.

As the fishing line 12 is deployed the device 10 assumes configuration A. In configuration A the device 10 is adjacent to, but laterally displaced from the main line 28 and is well separated from the fishing line 12. To the extent that the device 10 contacts the main line 28, its physical characteristics and properties reduce the likelihood of it becoming entangled with the main line 28. In particular, the buoyancy and semi-rigidity of the device 10. For example, in an aquatic environment with a density of about 1.205 g/cm³, the second housing 31 has a buoyant force of about 0.7036N.

Once the fishing line 12 is deployed, the device 10 assumes the first position in the form of configuration B, where it is more laterally displaced from the main line than configuration A. The main longitudinal axis of the electromagnetic shark control device 10 extends from the fishing line 12 and towards a surface of the sea water 200. The main longitudinal axis of the shark deterrent defines a first angle, in the form of an acute angle X1, with the fishing line 12. In configuration B, the electromagnetic field produced by the device 10 does not adversely impact on the area occupied by the fishing hooks 14a, 14b.

Upon retrieval of the fishing line 12, the device moves through configurations C and D to the second position in the form of configuration E (see FIG. 2B). This movement involves the device 10 pivoting around the point on the fishing line 12 where the device is attached thereto. In configuration E the main longitudinal axis of the device 10 extends away from the surface of the sea water 200 and defines a second angle with the line, in the form of an obtuse angle X2 with the fishing line 12. In configuration E, the electromagnetic field produced by the device 10 surrounds the area occupied by the fishing hooks 14a, 14b and hence reduces the likelihood of an aquatic animal, such as a fish 40, attached to fishing hook 14a being predated by a shark.

Again, to the extent that the device 10 contacts the fishing line 12, its physical characteristics and properties reduce the likelihood of it becoming entangled therewith. In particular, the buoyancy and semi-rigidity of the device 10. For example, in an aquatic environment with a density of about 1.205 g/cm³, the second housing 31 has a buoyant force of about 0.7036N.

1-59. (canceled)

60. A shark control device for a line including a hook member for catching an aquatic animal in an aquatic environment, the device comprising:
a shark deterrent having a predetermined buoyancy that is more buoyant than the aquatic environment such that, when the line is retrieved in the aquatic environment, the shark deterrent is adapted to move from a first position at which it is located above and spaced apart from or excludes the hook member to a second position at which it is adjacent to or encompasses the hook member.

61. The shark control device according to claim 60, wherein the shark deterrent is selected from the list comprising: a magnetic repellent, an electrical repellent, an acoustic repellent, a semiochemical repellent, and a visual repellent.

62. The shark control device according to claim 60, wherein the shark deterrent is more buoyant than the line.

63. The shark control device according to claim 60, wherein, when in the first position, a main longitudinal axis of the shark deterrent extends from the line and towards a surface of the aquatic environment.

64. The shark control device according to claim 63, wherein, when in the first position, the main longitudinal axis of the shark deterrent defines a first angle with the line in the form of an acute angle.

65. The shark control device according to claim 64, wherein the acute angle is about 35-55°, 40-50°, or 45°.

66. The shark control device according to claim 60, wherein, when in the second position, the main longitudinal axis of the shark deterrent extends from the line and away from the surface of the aquatic environment.

67. The shark control device according to claim 66, wherein, when in the second position, the main longitudinal axis of the shark deterrent defines a second angle with the line in the form of an obtuse angle.

68. The shark control device according to claim 67, wherein the obtuse angle is at least about 150°, 160°, 170°, or 175°.

69. The shark control device according to claim 60, wherein the movement between said first and second positions comprises reorientation of the shark deterrent.

70. The shark control device according to claim 69, wherein the reorientation comprises inversion of the shark deterrent.

71. The shark control device according to claim 60 adapted to be attached to the line at an attachment point on the line.

72. The shark control device according to claim 71, wherein the shark deterrent is adapted to fixedly attached to the line at the attachment point on the line.

73. The shark control device according to claim 72, wherein, when the shark deterrent is attached to the line at the attachment point on the line, the movement between said first and second positions comprises the shark deterrent pivoting around the attachment point on the line.

74. The shark control device according to claim 60, wherein the shark deterrent further comprises a means for attracting the aquatic animal or another animal upon which the aquatic animal predates.

75. The shark control device according to claim 60, wherein the shark deterrent is semi-rigid.

76. The shark control device according to claim 75, wherein shark deterrent has a rigidity quantified as a deflection of 8-12, 9-11, or 10 mm over a 1 m span upon application of a 10 g load.

77. The shark control device according to claim 60, wherein the shark deterrent is capable of plastic deformation.

78. A shark control device for a line including a hook member for catching an aquatic animal in an aquatic environment, the device comprising a shark deterrent in the form of an electromagnetic repellent having a predetermined buoyancy that is more buoyant than the aquatic environment such that, when the line is retrieved in the aquatic environment, the electromagnetic repellent is adapted to move from a first position at which it is located above and spaced apart from or excludes the hook member to a second position at which it is adjacent to or encompasses the hook member.

79. The shark control device according to claim 78 adapted to produce an electromagnetic field having (a) an electromagnetic strength that is 0.5-1.5V/m, 0.75-1.25V/m, 0.85-1.15V/m, 0.95-1.05V/m, or about 1V/m; (b) an electromagnetic pulse that is 3-7 pulses/second, 4-6 pulses/second, or about 5 pulses/second; or both (a) and (b).
